(19) United States
(12) Patent Application Publication
(10) Pub. No.: US 2009/0248888 A1
(43) Pub. Date: Oct. 1, 2009

(54) User-Selectable Streaming Audio Content for Network-Enabled Television

(75) Inventor: David Stifter, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/060,420

(22) Filed: Apr. 1, 2008

(51) Int. Cl. G06F 15/16

(52) U.S. Cl. 709/231

(57) ABSTRACT

User-selectable streaming audio content for a network-enabled television is provided. In one embodiment, displayable network content is provided to a user in a graphical user interface on a display of a network-enabled television. Streaming audio content may also be accessed and provided, where the category or source of such streaming audio content is based on a user selection. In one embodiment, the selected streaming audio content may then be provided to the user while also displaying the displayable network content. In another embodiment, streaming audio content may be provided to a user, wherein the streaming audio content may be temporarily paused in order to provide an audio component of requested network content to the user.

### FIELD OF THE INVENTION

The present invention relates generally to network-enabled television, and more particularly to providing user-selectable streaming audio content for network-enabled television.

### BACKGROUND OF THE INVENTION

Television manufacturers face increasing competition from online content providers. That is, users are increasing looking to the Internet to receive news, weather, sports and other content. In response, television manufacturers are being to offer Internet-enabled televisions, which allow users to browse the Internet, check emails, and even stream and download media right from their televisions without the need for any additional hardware or software. Such televisions even include user menus and interfaces for navigating through the various networking options.

In addition, broadcast networks know that the Internet offers a greater audience base and more opportunities for advertising, especially advertising of the interactive type that isn't possible through television alone. This all suggests that the Internet-enabled televisions are here to stay. Unfortunately, however, prior art Internet-enabled televisions have not been able to provide a full end-user experience. As such, an improved network-enabled television system and method capable of providing a more complete user experience may be desired.

### SUMMARY OF THE INVENTION

Disclosed and claimed herein are methods and network-enabled television system for providing user-selectable streaming audio content. In one embodiment, a method for providing user-selectable streaming audio content for a network-enabled television includes receiving a request from a user for displayable network content, and displaying network content in a graphical user interface on a display of a network-enabled television in response to the request. The method further includes accessing streaming audio content based on a user selection, and providing the streaming audio content to the user while displaying the network content.

In another embodiment, a method includes providing streaming audio content to a user, receiving a request from the user for network content having an audio component, and pausing the streaming audio content in response to the request for network content having the audio component. The method further includes providing the audio component of the network content to the user, and resuming the streaming audio content after the audio component of the network content is complete.

Other aspects, features, and techniques of the invention will be apparent to one skilled in the relevant art in view of the following description of the exemplary embodiments of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A illustrates a graphical user interface flow diagram in accordance with an embodiment of the invention;

FIG. 1B illustrate another graphical user interface usable for implementing one embodiment of the invention;

FIG. 2 illustrates still another embodiment of a graphical user interface configured in accordance with the principles of the invention;

FIG. 3 illustrates a process for carrying out one or more embodiments of the invention; and

FIG. 4 illustrates another process for carrying out one or more embodiments of the invention.

### DETAILED DESCRIPTION OF THE EXEMPLARY EMBODIMENTS

### Overview of the Disclosure

The present disclosure relates generally to providing user-selectable streaming audio content for a network-enabled television. In one embodiment, a user may provide a request to the network-enabled television for displayable network content. Such displayable network content may then be presented to the user in a graphical user interface on a display of a network-enabled television. In one embodiment, streaming audio content may also be accessed and provided, where the category or source of such streaming audio content is based on a user selection. The selected streaming audio content may then be provided to the user while also displaying the displayable network content. As such, the user may view displayable network content on a network-enabled television, while also receiving user-selected streaming audio content.

Another aspect of the disclosure relates to providing streaming audio content to a user, wherein the streaming audio content may be temporarily paused in order to provide an audio component of requested network content.

Hardware configurations and details of network-enabled televisions and television systems are generally known and beyond the scope of this disclosure. For example, network-enabled televisions and television systems typically include some type of a display (e.g., plasma, liquid crystal, etc.), processing circuitry, a power supply, and a memory having programming code executable by the processing circuitry for operating the device/system. Unlike traditional televisions, however, network-enabled televisions further include a network interface for coupling the device/system to a network, such as the Internet. Just as traditional televisions typically have numerous inputs, a network-enabled system includes an additional input, in the form of a network interface, for receiving network content.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, a radio frequency (RF) link, etc.

### Overview of an Exemplary Online Environment

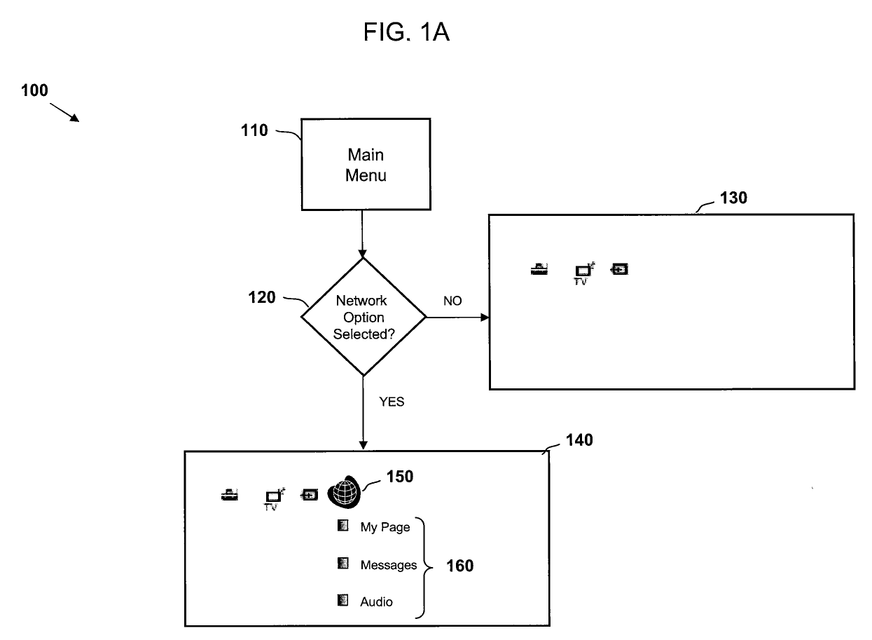

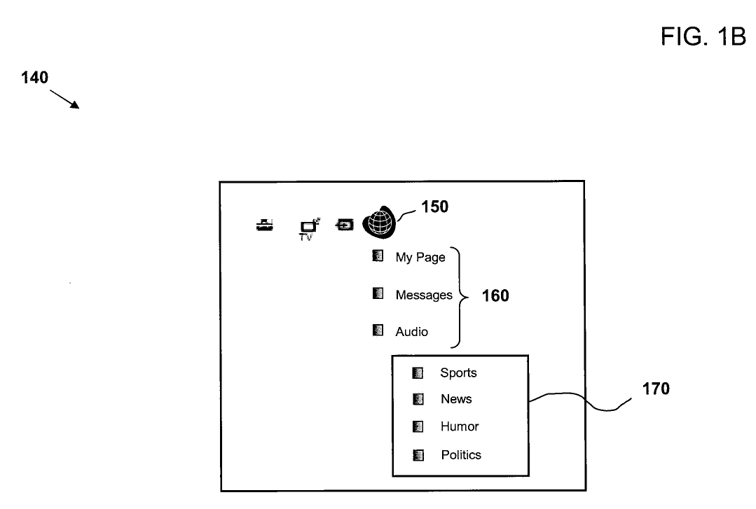

FIG. 1A is a schematic diagram depicting one embodiment of a user interface flow diagram 100 usable in connection with a network-enabled television system according to one embodiment of the invention. Diagram 100 begins at block 110 with a user accessing an onscreen display menu of a network-enabled television system, such as by selecting a “menu” option from a corresponding remote control to the network-enabled television system. In one embodiment, this onscreen main menu 110 corresponds to the televisions main settings and preferences menu, and may be used to access display setting, audio settings, available user features and the like.

At block 120, a determination may then be made as to whether a network option has been selected or is otherwise detected. If not, a standard or non-network user interface, such as interface 130, may be displayed to the user. From this interface 130, a user may select from among the displayed icons to access and/or modify various system setting and the like. If, on the other hand, network functionality is available, then user interface 140 may instead be displayed to the user.

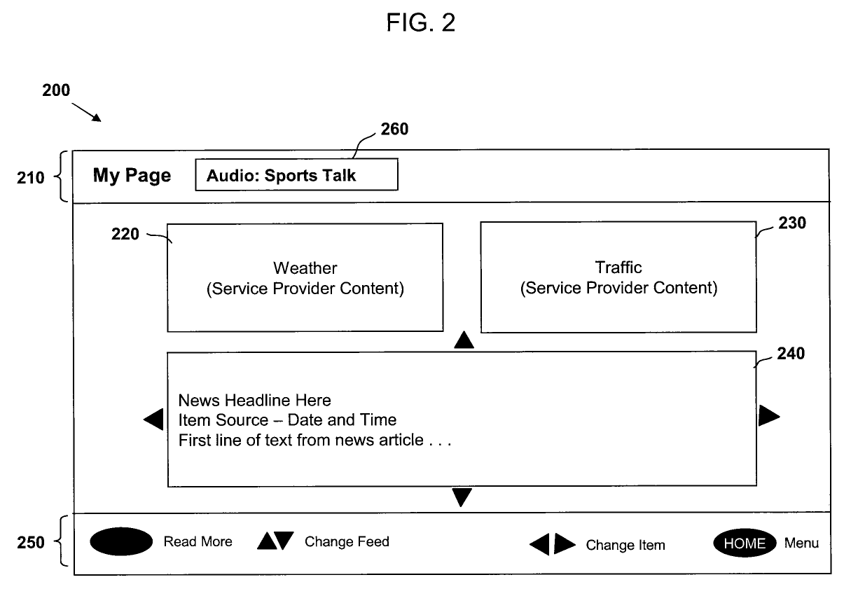

When network functionality is available, in addition to the icons available on the standard interface 130, a network icon 150 may also be provided to the user, as depicted on user interface 140. By selecting the network icon 150, a list or submenu 160 of network-related features also may be displayed to the user as part of the interface 140. For example, the network-related feature on submenu 160 called “My Page” may relate to a portal or browser (see FIG. 2 below) from which the user may view/access network content from various service providers. By way of providing non-limiting examples, such content may include local news, weather, traffic information, etc. The network-related feature on submenu 160 called “Messages” may enable the user to access his/her emails, text messages, etc. Finally, the audio feature of submenu 160 may correspond to user-selectable streaming audio content, as will be described in more detail below.

While numerous configurations are possible and would be apparent to one skilled in the art, in certain embodiments, the network-enabled television on which interfaces 130 and 140 may be displayed may comprise a television configured to access a network, such as the Internet, either directly or in combination with integrated and/or self-contained networking circuitry attached thereto

Referring now to FIG. 1B, depicted therein is the user interface 140 after the user has selected the “audio” feature from submenu 160. As shown, the user may subsequently be presented with submenu 170 corresponding to a plurality of available streaming audio content categories (e.g., sports, local news, national news, international news, entertainment news, talk shows, humor, politics, music, etc.). From this submenu 170, the user may select a streaming audio content source or category, which may be streamed to the user during, or in combination with, subsequent network content presentation. Such streaming audio content may be similarly provided to the user during navigation of a network portal or browser (e.g., My Page) of the network-enabled television system.

Referring now to FIG. 2, depicted is one embodiment of a portal or user interface 200 for accessing network content on a network-enabled television system. In particular, the interface 200 of FIG. 2 corresponds to the previously-described “My Page” accessible from submenu 160 of FIGS. 1A-1B.

In the embodiment of FIG. 2, the interface 200 may include an information bar 210 usable to provide the user with a whole host of information corresponding the current portal, network content, preferences, etc. The interface 200 may further include one or more content windows or sections, which in the embodiment of FIG. 2 includes content windows 220, 230 and 240. In particular, content window 220 includes network content corresponding to weather information provided by a particular service provider, while content window 230 includes network content corresponding to traffic conditions. Window 240 of FIG. 2 corresponds to a news related content, which in one embodiment may be a Really Simple Syndication (RSS) news feed provided by an RSS service provider.

Interface 200 may further comprise a navigation bar 250, usable for browsing through one or more additional network-related interfaces, such as interface 200, on the network-enabled television, as well as for navigating through and requesting available the network content from interface 200.

Finally, interface 200 further includes audio indicator 260, which in one embodiment is usable to indicate to the user the currently-selected source or category of streaming audio content. In one embodiment, the currently-selected source or category of streaming audio content that is displayed by indicator 260 may correspond to a selection made by the user, such as via submenus 160 and 170 of FIGS. 1A-1B. In this fashion, a user may select what streaming audio content to listen to while also being presented with network content, such as weather, traffic, news, etc. Since the requested network content may not have an audible component, this embodiment may improve the user's experience since the user will be able to enjoy both audio and visual-based content at the same time, despite the fact that the displayable network content may not have sound.

It should be appreciated that more or fewer than three content windows may be displayed at any one time using interface 200, and that such content windows may not actually be separate windows, but may instead simply correspond to different areas or sections of the interface 200. Additionally, the particular content used to populate such windows/sections of interface 200 may

It should be appreciated that the content populating the various windows of interface 200 may be user-defined and/or based on one or more user-selected preferences.

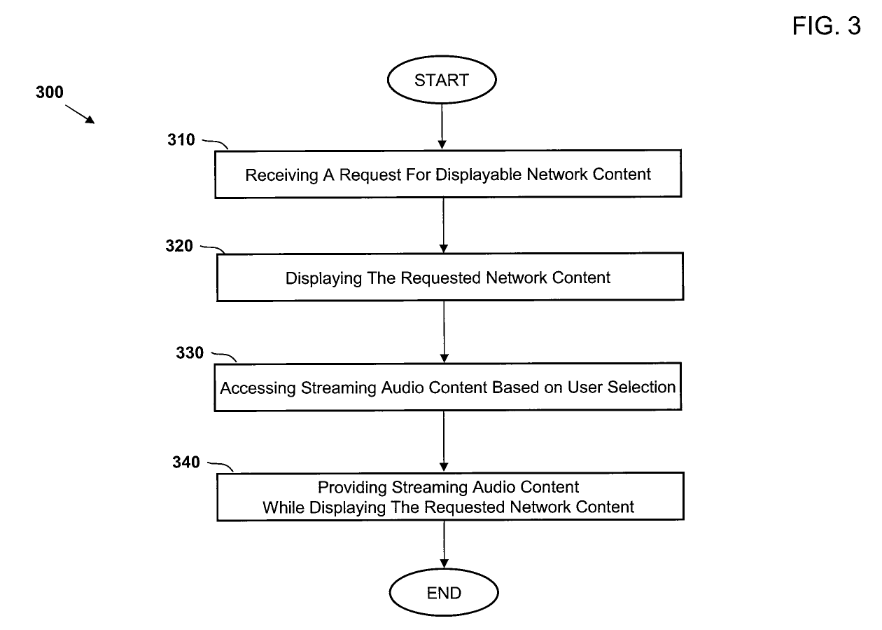

Referring now to FIG. 3, depicted is one embodiment of a process 300 for carrying out one or more aspects of the invention using a network-enabled television system. In particular, process 300 begins at block 310 with the receiving of a request for displayable network content. In one embodiment, this request may correspond to a user request which is provided to the network-enabled television system using, for example, a remote control or any other user input means. In certain embodiments, this request may be provided using one or more menus or submenus (e.g., submenu 160, etc.) and/or interfaces (e.g., interface 140, interface 200, etc.). In any event, process 300 may then continue to block 320 where the requested displayable network content may then be displayed. In one embodiment, the displayable network content may be displayed in a graphical user interface (e.g., interface 200) on a display of a network-enabled television in response to the request of block 310.

Continuing to refer to FIG. 3, process 300 continues to block 330 where, based on a user selection, streaming audio content may be accessed. In one embodiment, the user selection may have been previously provided using one more menus and/or submenus, as described above with reference to FIGS. 1A-1B. This user selection may be an actual selection of a category or source of streaming audio content, or in another embodiment may be a user preference. In certain embodiments, the streaming audio content corresponding to the user selection may be accessed by the network-enabled televisions system from any streaming media source over the Internet, for example.

Process 300 may then continue to block 340 where the accessed streaming audio content may then be provided to the user while also displaying the requested displayable network content of block 320. In one embodiment, the displayable network content may be displayed using an interface of the television system (e.g., interface 200), while the televisions system also provides an audio signal carrying the streaming audio content to a speaker. While in one embodiment, the speaker may be integrated with the network-enabled television system, in another embodiment the network-enabled television may provide an “audio out” connection to an external audio system. Additional details of providing audio signals from televisions are known in the art and beyond the scope of this disclosure.

While process 300 suggests that the requested network content may be displayed before the streaming audio content is accessed and provided, it should be appreciated that in other embodiments the streaming audio content may already be playing before or simultaneously with the request and displaying of the displayable network content.

In this fashion, users may enjoy viewing displayable network content on a network-enabled television, while also being able to enjoy user-selected streaming audio content, despite the fact that the requested displayable network content may not have an audible component.

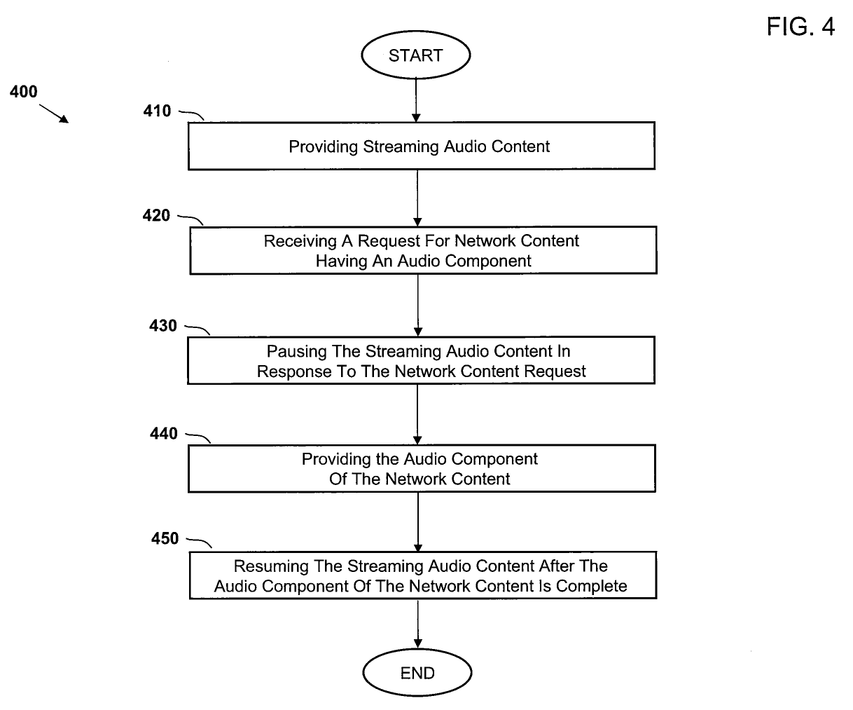

Referring now to FIG. 4, another embodiment of a process 400 for providing user-selectable streaming audio content on a network-enabled television system is depicted. Process 400 begins at block 410 where streaming audio content may be provided to a user of a network-enabled television system. As described above with reference to FIG. 3, such streaming audio content may be provided from any streaming media source available over the Internet, for example. Moreover, this streaming media content may correspond to a previously-received user selection or preference setting corresponding to a category or source of streaming audio content. It should also be appreciated that the streaming audio content of block 410 may be provided as an audio signal carrying the streaming audio content to any speaker or audio output device.

Process 400 may then continue to block 420 where a request may be received from the user for network content, which in one embodiment may have an audio component (e.g., an RSS feed). In one embodiment, this request may correspond to a user request which is provided to the network-enabled television system using, for example, a remote control or any other user input means. In certain embodiments, this request may be provided using one or more menus or submenus (e.g., submenu 160, etc.) and/or interfaces (e.g., interface 140, interface 200, etc.).

Process 400 may then continue to block 430 where the streaming audio content of block 410 being provided to the user may be paused at block 420. In one embodiment, this pausing may be initiated in response to detecting that the requested network content includes an audio component. While it should be appreciated that this detecting may be accomplished using any known methodology, in one embodiment the network-enabled television system may include software and/or hardware circuitry (e.g. sound card) configured to read an incoming digital data bit stream and to identify when it contains an audio component.

Process 400 may then continue to block 440 where the requested network content, including the audio component thereof, may be provided to the user. In the event that the requested network content includes both an audio and displayable component, the displayable component may be displayed using a graphical user interface (e.g., interface 200) on a display of a network-enabled television, while the audio component is being provided to the user. By way of example, an RSS feed may include both a displayable portion which can be presented to the user on a user interface of the network-enabled television, as well as an audio component which may be played for the user through any type of speaker device.

Continuing to refer to FIG. 4, process 400 may then continue to block 450 where, the streaming audio content of block 410 may be resumed after the audio component of the network content has been completed. In this fashion, users may enjoy network content on a network-enabled television, while also being able to enjoy user-selected streaming audio content which does not interfere with potential audio components of the user-requested network content.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for providing user-selectable streaming audio content for a network-enabled television, the method comprising the acts of:
receiving a request from a user for displayable network content;
displaying network content in a graphical user interface on a display of a network-enabled television in response to said request;
accessing streaming audio content based on a user selection; and
providing the streaming audio content to the user while displaying the network content.

2. The method of claim 1, further comprising accessing the graphical user interface from an onscreen display menu of the network-enabled television.

3. The method of claim 1, wherein accessing streaming audio content comprises accessing streaming audio content over a data network.

4. The method of claim 1, further comprising receiving said user selection from the user, wherein the user selection corresponds to a category/source of said streaming audio content.

5. The method of claim 1, wherein providing the streaming audio content comprises providing an audio signal carrying the streaming audio content to a speaker electrically connected to the network-enabled television.

6. The method of claim 1, wherein said displaying the network content comprises displaying the network content prior to said accessing the streaming audio content.

7. The method of claim 1, further comprising:
receiving a network content request from the user for network content, wherein the network content has an audio component; and
pausing said streaming audio content in response to said network content request for network content having the audio component.

8. A method for providing user-selectable streaming audio content for a network-enabled television, the method comprising the acts of:
providing streaming audio content to a user;
receiving a request from the user for network content having an audio component;
pausing said streaming audio content in response to said request for network content having the audio component;
providing the audio component of the network content to the user; and
resuming the streaming audio content after the audio component of the network content is complete.

9. The method of claim 8, wherein providing streaming audio content comprising providing the streaming audio content based on a user selection.

10. The method of claim 9, wherein the user selection is provided via a graphical user interface from an onscreen display menu of the network-enabled television.

11. The method of claim 10, further comprising receiving said user selection from the user, wherein the user selection corresponds to a category/source of said streaming audio content.

12. The method of claim 8, wherein providing streaming audio content comprises accessing streaming audio content over a data network.

13. The method of claim 8, further comprising detecting the audio component in an incoming digital data stream of the network content.

14. The method of claim 8, further comprising displaying a displayable component of the network content in a graphical user interface on a display of a network-enabled television.

15. A network-enabled television system comprising:
a display;
a network interface;
a processor electrically coupled to the display and the network interface, wherein the processor is to:
receive a request from a user for displayable network content;
display network content in a graphical user interface on the display;
access streaming audio content based on a user selection; and
provide the streaming audio content to the user while displaying the network content.

16. The network-enabled television system of claim 15, wherein the processor is further to access the streaming audio content over a data network via the network interface.

17. The network-enabled television system of claim 15, wherein the processor is further to receive said user selection from the user, wherein the user selection corresponds to a category/source of said streaming audio content.

18. The network-enabled television system of claim 15, wherein the processor is further to display the network content prior to accessing the streaming audio content.

19. The network-enabled television system of claim 15, wherein the processor is further to:
receive a network content request from the user for network content, wherein the network content has an audio component; and
pause said streaming audio content in response to said network content request for the network content having the audio component.
